(19) United States
(12) Patent Application Publication
(10) Pub. No.: US 2016/0203724 A1
(43) Pub. Date: Jul. 14, 2016

(54) Social Classroom Integration And Content Management

(71) Applicant: Apollo Education Group, Inc., Phoenix, AZ (US)

(72) Inventors: Ginny Heenan, Belmont, CA (US); Pankaj Mishra, Tempe, AZ (US); Nitin Mulimani, Tempe, AZ (US); Brig Lamoreaux, Gilbert, AZ (US)

(21) Appl. No.: 14/595,458

(22) Filed: Jan. 13, 2015

(51) Int. Cl. G09B 5/00; G09B 7/00

(52) U.S. Cl. CPC G09B 5/00; G09B 7/00

(57) ABSTRACT

Social classroom integration and content management are provided. An extended group is established for a course divided into a plurality of ordered sections. Members of the extended group are enabled to access content items provided by other members of the extended group. First members are added to the extended group based on being registered in a first course offering. After a first ordered section of the course has been completed in the first course offering, and before a last ordered section of the course has been completed in the first course offering, a second course offering of the course is started, second members are added to the extended group based being registered in the second course offering, and the second members are allowed to access at least some of the content items that were provided by the first members when the first course offering was in the first section.

### FIELD OF THE INVENTION

Embodiments of the invention described herein relate generally to computer systems, and, more specifically, to content management.

### BACKGROUND

Typically, an online course has a corresponding home web address that identifies a web resource. The web resource has information about the course, such as a course syllabus, course schedule, or other course information. A user may access the web resource of the online course through a web browser, a mobile or desktop application, or any other type of web resource viewer.

In a live classroom setting, students have in-person access to their classmates. Such social interaction in a classroom setting increases engagement and participation, and may improve performance for students to take advantage of such collaboration. When a course is offered online, the user may be provided electronic access to a group of classmates enrolled in the same course offering. Such electronic access is referred to herein as “electronic peer access”. Electronic peer access enhances the online experience of a student by simulating the same type of interactions that occur in a physical classroom of individuals enrolled in the same course offering. For example, electronic peer access may involve use of a message board that is dedicated to the course offering. Such a message board may be available to the classmates and/or faculty teaching the particular course offering.

Typically, user engagement in electronic peer access is low, despite the fact that user engagement in electronic peer access is correlated with better performance and completion for individual courses as well as educational programs. Conventionally, when electronic peer access is implemented for an online course offering, content contributed by a member of the group is restricted to the other classmates in that same online course offering, and becomes unavailable once that course offering ends. Furthermore, the quality of the user-provided content for a particular course is not consistent between different offerings of that same course.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram depicting an example system architecture;

FIG. 2 is a diagram depicting accepting, scoring and displaying a content item, according to one embodiment;

FIG. 3 is a flow diagram that illustrates an embodiment of a process for managing an extended educational network group for a course;

FIG. 4 is a flow diagram that illustrates an embodiment of a process for removing members from an educational network group who are no longer registered in the corresponding course;

FIG. 5 is a flow diagram that illustrates an embodiment of a process for scoring a content item; and

FIG. 6 illustrates a computer system upon which one or more embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are described herein for extending electronic peer access of a student in a particular course offering beyond those other students in the same course offering. For example, a student in a course offering may have electronic peer access to an “extended group” that includes students from multiple course offerings of the course. Membership in the extended group is automatically provisioned, and members are added or removed based on current registration in the course.

Members of the extended group generate content items that are made available electronically to other members of the extended group. These content items submitted by extended group members are considered “social content.” According to one embodiment, content items are scored based on one or more scoring metrics. These scores are used to identify “quality content items” that are treated differently than other content items. For example, quality content items may be allowed to persist in the extended group longer than other content items. As another example, quality content items may be selected as top content items for display. or may be used to customize content items for display to a particular member.

Various techniques are described herein for scoring content items submitted by members of the extended group. Scoring of a particular content item may be based on a combination of one or more factors such as the performance of members who have viewed the particular content item, the performance of members who have not view the particular content item, the relevance of the particular content item, an affinity of the particular content item, and voting with respect to the particular content item by other members of the extended group. In one embodiment, scoring metrics are defined for such factors, and the score of a content item is a function of these scoring metrics. The score of the particular content item may be reevaluated over time.

One or more embodiments are directed to providing an integrated classroom experience for a course that includes social content generated by members of the corresponding extended group. For example, for a course that is divided into a number of ordered sections, a classroom interface may be displayed that includes both syllabus information and social content. The social content may be presented based on content item scores.

### System Overview

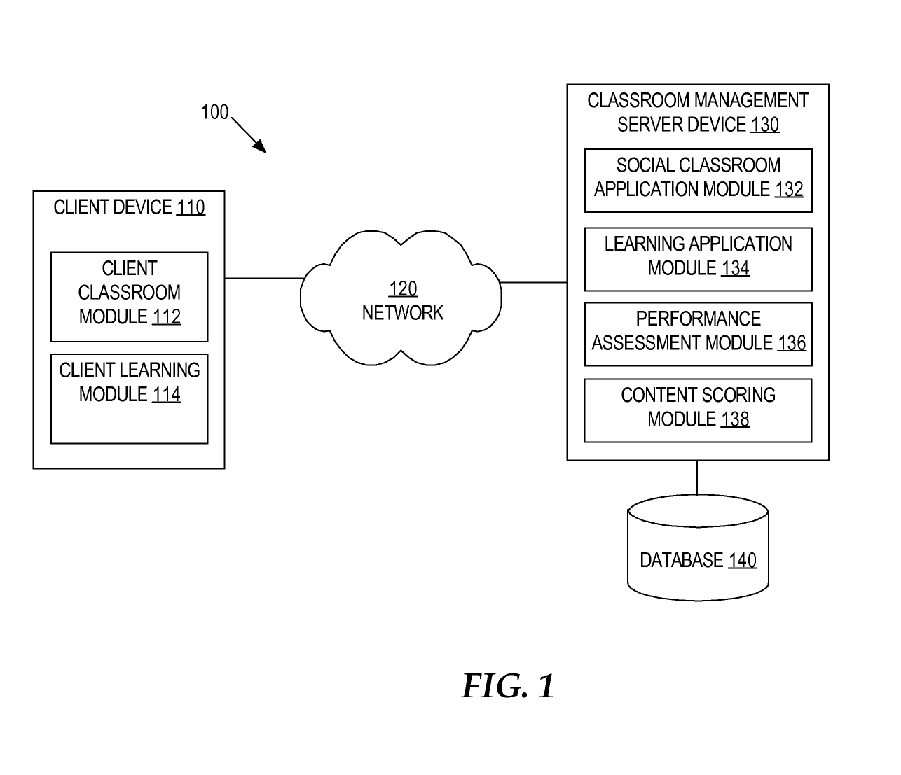

FIG. 1 is a block diagram of a system 100 for social classroom integration and content management, according to an embodiment. System 100 includes a client device 110, a classroom management server device 130, a network 120, and a database 140. Each of these components of the system 100 shall be described in greater detail hereafter. In one embodiment, components of system 100 communicate via one or more Application Programming Interface (API) calls, Simple Object Access Protocol (SOAP) messages, requests via HyperText Transfer Protocol (HTTP), HyperText Transfer Protocol Secure (HTTPS), Simple Mail Transfer Protocol (SMTP), or any other kind of communication.

### Client Device

Client device 110 generally represents a device used by a user that is taking a course. Although one client device 110 is shown in system 100, system 100 may support a plurality of client devices 110. That is, each user can have multiple client devices, and the system architecture may support any number of users.

Client device 110 is communicatively coupled to network 120, such as a local area network, the Internet, or any other computer network. Client device 110 is configured to communicate with at least classroom management server device 130 over network 120. Client device 110 may be implemented by any type of computing device, including but not limited to workstations, personal computers, laptop computers, personal digital assistants (PDAs), tablet devices, mobile devices such as smart phones, and any other computing devices.

In the illustrated embodiment, client device 110 is configured to execute client classroom module 112 and client learning module 114. Client classroom module 112 and client learning module 114 may be part of the same software application or different software applications, including web application/s and/or mobile application/s.

Client classroom module 112 is configured to perform client-side social classroom functions, such as displaying social content corresponding to a course to the user that is enrolled in the course. Client classroom module 112 may also be configured to accept and submit to classroom management server device 130 social content generated by the user of client device 110. In one embodiment, client classroom module 112 is configured to display a classroom interface on client device 110. The classroom interface may be displayed in a web browser, a web application, a mobile application, and/or any other application. The classroom interface includes course information that is integrated with social content for the course. In one embodiment, client classroom module 112 obtains social content from social classroom application module 132 of classroom management server device 130. The social content for the course is generated by other members of the extended group. The social content may include content items from current members, and may also include content items from past members. Social content for an extended group corresponding to a course shall be described in greater detail hereafter.

Client learning module 114 is configured to perform client-side learning activity functions, such as presenting at least a portion of a learning activity to a user on client device 110. For example, learning module 114 may display a document or other educational media, including text, audio and/or video. Learning module 114 may further display one or more interactive learning activities, such as a quiz, a test, another performance assessment, a live conference, or another interactive learning activity. Client learning module 114 may display such content in a learning interface on client device 110. The learning interface may be displayed in a web browser, a web application, a mobile application, and/or any other application. In one embodiment, client learning module 114 obtains learning activity data from learning application module 134 of classroom management server device 130.

In one embodiment, client classroom module 112 and client learning module 114 are integrated to provide a seamless experience to a user enrolled in a particular course who is also a member and the corresponding extended group. For example, client learning module 114 may provide a learning activity that involves displaying social content comprising a plurality of user-submitted quiz questions.

### Social Content

Social content includes content items generated and submitted by members of the extended group. Examples of social content include questions asked by members, answers provided by members, practice question-answer pairs created by members, discussions regarding learning activities, and other social participation submitted by members. Social content may also include submissions of external references, such as links to videos, articles, and other web resources. In one embodiment, social content includes links to content that is external to the course material of the corresponding course, but accessible through classroom management server device 130.

### Course Sections

A course may be divided into a plurality of ordered sections. For example, a course may be divided into chapters or other sections of a course textbook, chapters or sections of other course material, a course syllabus, a course schedule, or any other division of the course indicating that the learning activities of the course should be completed in the prescribed order. For example, the course may be divided into sections that each correspond to a week of the course. Each section may include a set of learning activities, such as reading, quizzes, assessments or the like, to be completed during the week.

In one embodiment, a particular ordered section is made available to members registered in a particular course offering when the schedule of the particular course offering indicates that the particular ordered section is reached. For example, assume that a course is divided into ordered weekly sections. During Week 1 of the particular course offering, a registered user in the course offering may only have access to social content associated with Week 1. On the other hand, at Week 5 of the particular course offering, the same user would be able to access social content associated with any of Weeks 1, 2, 3, 4 and 5 of the course.

### Classroom Management Server Device

Classroom management server device 130 generally represents a server device configured to perform online classroom management functions. Classroom management server device 130 includes social classroom application module 132, learning application module 134, performance assessment module 136, and content scoring module 138, each of which shall be described in greater detail hereafter. Although one classroom management server device 130 is shown in system 100, system 100 may include a plurality of classroom management server devices 130. For example, classroom management server device 130 may be provided as a distributed system or may be implemented in one or more cloud computing devices. Furthermore, although social classroom application module 132, learning application module 134, performance assessment module 136 and content scoring module 138 are illustrated as modules of one classroom management server device 130, one or more of the aforementioned modules may be implemented on separate classroom management server devices 130 in communication with each other, such as via network 120.

### Social Classroom Application Module

Social classroom application module 132 manages extended groups for one or more courses. For example, social classroom application module 132 may automatically provision membership in an extended group. Social classroom application module 132 may also accept, store, maintain and curate social content generated by members of the extended groups, which shall be described in greater detail hereafter. In one embodiment, social classroom application module 132 processes content items, generates the appropriate metadata, and stores the content items and metadata in database 140. In one embodiment, social classroom application module 132 interacts with client classroom module 112 of client device 110 over network 120.

### Learning Application Module

Learning application module 134 manages course information and learning activities for one or more courses. In one embodiment, learning application module 134 interacts with client learning module 114 of client device 110 over network 120. Learning application module 134 may be configured to provide a virtual classroom to a user of client device 110 that is registered for a course offering of a particular course. The user may be a member of the corresponding extended group managed by social classroom application module 132.

### Performance Assessment Module

Performance assessment module 136 assesses performance of one or more members of an extended group of a course. For example, performance assessment module 136 may perform an assessment of one or more assignments, quizzes, or other learning activities. In one embodiment, the learning activity is designed to be computer-assessed to facilitate assessment by performance assessment module 136. In one embodiment, performance assessment module 136 stores assessment data in database 140. The assessment data may be used by other components of classroom management server device 130, such as content scoring module 138.

### Content Scoring Module

Content scoring module 138 scores content items. In one embodiment, content scoring module 138 generates scores for content items based on one or more scoring metrics. The content item scores generated by content scoring module 138 may be used for the purpose of selecting top content for display, selecting customized content for display to a particular member, determining quality content to persist, or for other purposes, which shall be described in greater detail hereafter.

### Extended Group Membership

According to one embodiment, extended groups are created and maintained on a per-course basis, not a per-course-offering basis. Thus, the membership of an extended group can include students from multiple course offerings of the same course. Social classroom application module 132 automatically provisions membership in the extended group for a course. For example, based on a current registration status of one or more users in a particular course, application social classroom application module 132 may automatically add or remove one or more users to the corresponding extended group.

In one embodiment, instructors, assistants, volunteers, or other managing members of the course may also be included in the extended group of the course. Thus, students enrolled in a particular course offering have access to the faculty of other course offerings of the same course, in addition to the faculty of the course offering in which they are actually enrolled. In one embodiment, other managing members of the course may include student users who were previously registered in the course who have been identified as valuable extended group contributors. For example, members who have generated high-scoring content may be candidates for retaining as members of an extended group after they had completed the course.

In one embodiment, the extended group includes student users who are currently registered for the same course in a different course offering of the course. The educational content covered in each course offering remains the same. However, the course offerings may have different classroom schedules, course starting dates, instructors, geographic locations, classmates, or other differences that cause the course offerings to be distinguished from each other. For example, a new course offering of a particular ten-week course may begin every three weeks. In this case, at the start of week 10 of the first course offering, the extended group for the course may include:
students/faculty from the course offering that began nine weeks ago,
students/faculty from the course offering that began six weeks ago,
students/faculty from the course offering that began three weeks ago, and
students/faculty from the course offering that just started.

In another example, different course offerings of the same course are provided at different campuses of an educational center, and the corresponding extended group includes members registered at the different campuses for the different course offerings.

In one embodiment, an extended group includes students in different but related courses. For example, when two courses each have one or more sections that correspond to the same material, the students of each course may be added to the extended group with respect to the overlapping material. For example, if a Humanities class and an Architecture class both include a similar Roman Architecture section, students from both courses may be added to the same extended group.

### Expert Member

Extended group membership may be offered to students/faculty that are not currently registered for a course offering and/or teaching a course offering. For example, a student who was generated high-scoring content may be candidates may be retained as an expert member of an extended group after they had completed the course. The expert member is allowed to contribute new material to the extended group even though he is not currently registered for a course offering and/or teaching a course offering.

Removing Social Content from the Extended Group

When the registration status of a member of an extended group changes and the member is no longer registered in the course that corresponds to an extended group, the member may be automatically removed from the extended group. In one embodiment, when a member is removed from the extended group, social content generated by the member is removed from the social content that is made available to the extended group.

However, in embodiments that shall be described hereafter, social content generated by some members of the extended group may continue to be made available to the extended group even after the members leave the extended group. For example, social content may be retained for the extended group after the user that provided the social content has left the extended group if, for example, the content is identified as “quality content”. In one embodiment, content scoring module 138 generates scores for content items. Those scores are used to determine which social content qualifies as quality content. The scoring of content items shall be described in greater detail hereafter.

In one embodiment, removal of social content is performed based on a removal-triggering event. In one embodiment, social content is evaluated for removal upon occurrence of a removal triggering event that relates to the particular social content, such as when a creator of the content is removed from the extended group, when a course-offering associated with the content completes, when a creator of the content ceases to be enrolled in any course in the educational system, after a set period of time elapses from such an event, at the beginning or end of an educational semester, year or other period, or other events that may serve as a trigger for removal. In one embodiment, it is determined to retain particular social content after evaluating the social content due to a removal-triggering event. Social content that has been evaluated and retained may still be subject to future evaluations for removal.

### Content Metadata

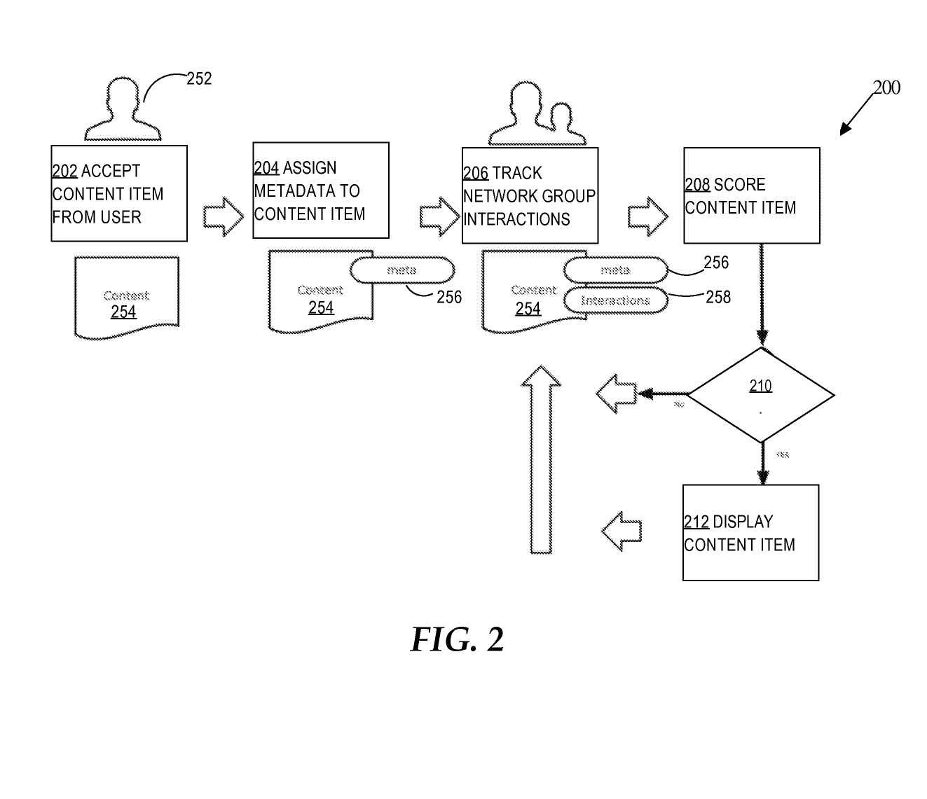

Social classroom application module 132 may assign metadata to content items. FIG. 2 is a diagram depicting a content item 254, and the process of accepting, scoring and displaying the content item 254. At block 202, social classroom application module 132 accepts a content item 254 from a submitting member 252. At block 204, social classroom application module 132 assigns metadata 256 to the content item 254. For example, if content item 254 is submitted for section “Week 2” of course “MATH 101”, social classroom application module 132 may generate metadata 256 for the content item 254 that indicates that content item 254 is associated with the course “MATH 101” and the section “Week 2”. Metadata 256 may also include, for example, metadata that identifies the member 252 that submitted content item 254. Content item 254 and its metadata 256 may be stored in database 140.

In one embodiment, social classroom application module 132 automatically detects the appropriate section in course to associate with content 254. For example, in a course divided into weekly sections, when member 252 submits content item 254 using client classroom module 112 during Week 2 of the course, that content item 254 may be associated with Week 2. Alternatively, member 252 may submit content item 254 for a prior week. For example, if the submitting member 252 is reviewing content corresponding to Week 1 using client learning module 114, and the submitting member 252 submits a question regarding the Week 1 content using client classroom module 112, social classroom application module 132 may detect that the submitted question corresponds to Week 1 rather than the current week, and may store metadata to indicate that the question is a content item for Week 1.

### User Interaction Metadata

In one embodiment, social classroom application module 132 also stores interaction metadata 258 with content item 254. At block 206, social classroom application module 132 tracks interactions of members of the extended group with content item 254, and stores data about those interactions, in association with the content item 254, as interaction metadata 258. In one embodiment, interaction metadata 258 includes data identifying members of the extended group that have interacted with the content item 254. For example, when the content item 254 comprises a link to an external resource, social classroom application module 132 may store interaction metadata 258 that identifies members of the extended group that have clicked on the link to the external resource.

### Scoring Metrics

Content scoring module 138 may score one or more content items based on one or more scoring metrics. As described in greater detail hereafter, the content item scores generated by content scoring module 138 may be used in a variety of ways, including but not limited to:
selecting top content for display
selecting customized content for display to a particular member of an extended group
determining “quality content” which, as mentioned above, may continue to be available to the extended group after the user that provided the content has left the extended group

Content scoring module 138 may use any combination of scoring metrics to generate a score for a content item, and may use different combinations of scoring metrics in different situations. Furthermore, content scoring module 138 may periodically reevaluate one or more scores for a particular content item. For example, the relevance of a particular content item may change over time, and this change may affect the relevance metric of the particular content item, and thereby affect the score of the particular content item.

Examples of scoring metrics include:

viewer outcome metrics;

non-viewer outcome metrics;

relevance metrics;

affinity metrics;

voting metrics.

This list is a non-limiting set of example metrics that may be calculated for the purpose of scoring a content item. These metrics are each described in greater detail hereafter.

### Scoring Content Items Based on Outcomes

In one embodiment, the score of a content item is a function of its effect on the performance of other members of the extended group. For example, the score of a content item may be a function of how well viewers of the content item perform on an assessment relative to how well non-viewers of the content item perform on the same assessment. If viewers of a content item score, on average, significantly higher on an assessment than non-viewers of the content item, then the viewer outcome metric would be significantly higher than the non-viewer outcome metric. The combination of a high viewer outcome metric and a low non-viewer outcome metric increases the score assigned to the content item.

For example, if a member submits a content item for a section, Week 2, of a course, an outcome metric for the content item may be calculated based on performance of members of the extended group on an assignment and/or quiz for Week 2. More specifically, content scoring module 138 may calculate a viewer outcome metric based on the performance of members who viewed the content item, and content scoring module 138 may calculate a non-viewer outcome metric based on the performance of one or more members who did not view the content item. In one embodiment, content scoring module 138 calculates outcome metrics based on existing assessment data generated by performance assessment module 136. For example, performance assessment module 136 may assess the assignment and/or quiz for Week 2. In one embodiment, performance assessment module 136 stores the assessment data for individual members in database 140, and content scoring module 138 accesses the stored assessment data in order to score the content item.

In one embodiment, in addition to or instead of basing a content item's performance metrics based on performance of current members of the extended group, the viewer outcome metric and the non-viewer outcome metric may be based on the performance of people that are no longer members of the extended group (“historical members” of the extended group). Content scoring module 138 may weigh the performance of current members of the extended group more heavily than the performance of historical members of the extended group. Likewise, content scoring module 138 may weigh the performance of more recent historical members more heavily than the performance of older historical members of the extended group.

Although the viewer outcome metric and the non-viewer outcome metric are described in detail in this example, one or more other performance-based metrics may be used to score one or more content items, either alone or in conjunction with any combination of the scoring metrics described herein.

### Scoring Content Items Based on Relevance

In one embodiment, the score of the content item is a function of relevance. A “relevance metric” is any metric that quantifies a level of relevance that the content item has with respect to the associated course or topic within the course. For example, a relevance metric may be based on one or more time factors, such as the age of a content item, the amount of recent interaction with the content item by members, or other time factors. One or more other relevance metrics may be used to score one or more content items, either alone or in conjunction with any combination of the scoring metrics described herein.

### Scoring Content Items Based on Affinity

In one embodiment, the score of a content item is a function of affinity. As used herein, the term “affinity” refers to a high level of interaction between members of the extended group and the content item. Thus, an “affinity metric” is any metric that quantifies a level of interaction with the content item. Various affinity metrics may be used by content scoring module 138. For example, an affinity metric may be based on an amount of time that a member interacts with the content item when the content item is displayed to the member. When the content item includes a link, the affinity metric may be based on whether members follow the link when the content item is displayed. One or more other affinity metrics may be used to score one or more content items, either alone or in conjunction with any combination of the scoring metrics described herein.

### Scoring Content Items Based on Voting

In one embodiment, social classroom application module 132 allows members of the extended group to rate content items. For example, members can rate content items according to a numerical rating (e.g. 5 stars), a binary rating (e.g. thumbs up, thumbs down), or in accordance with any other rating scheme. Furthermore, members can rate content items according to different categories, such as usefulness, entertainment value, and other categories. Various voting metrics may be defined based on such content item ratings. For example, a voting metric may be a function of all the ratings received for a content item. In one embodiment, a voting metric is a function of weighted ratings that are weighted based on factors such as recentness of the vote, a reputation rating of the voting member, a participation rating of the voting member, or other such factors. One or more other voting metrics may be used to score one or more content items, either alone or in conjunction with any combination of the scoring metrics described herein.

### Example Process for Scoring a Content Item

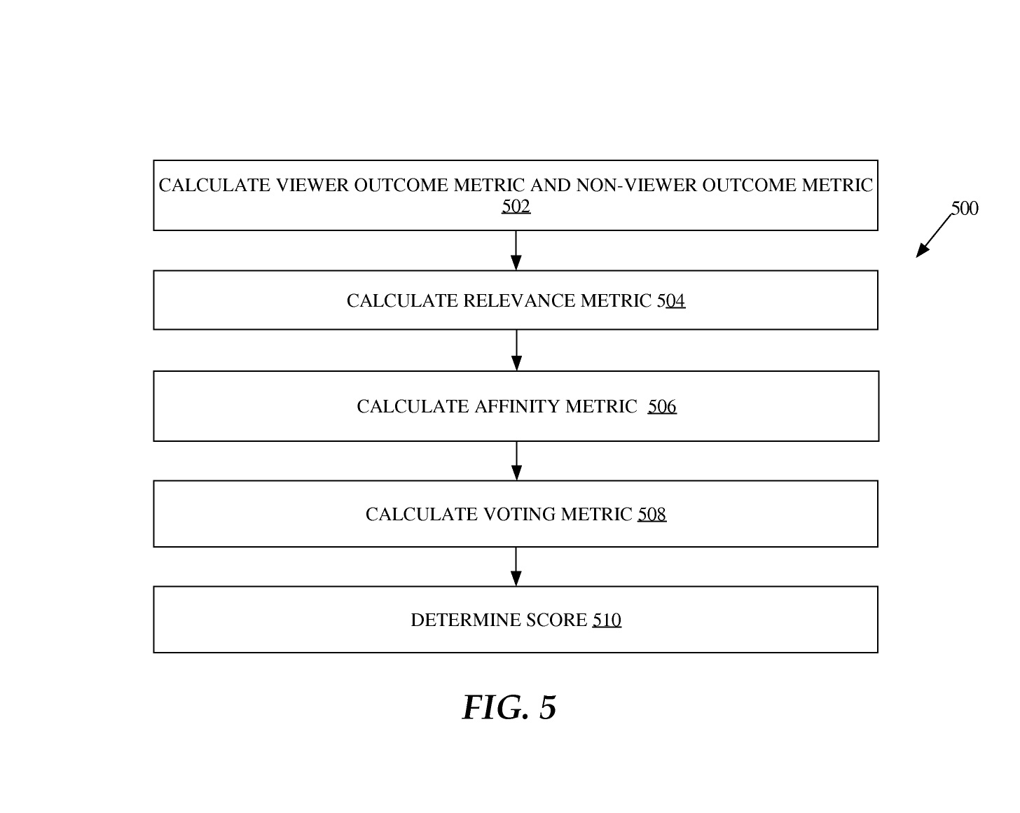

FIG. 5 is a flow diagram that illustrates an embodiment of a process for scoring a content item. Process 500 is performed by one or more computing devices and/or processes thereof, such as computing device 600. For example, one or more classroom management server devices 130 may perform process 500.

At block 502, content scoring module 138 calculates a viewer outcome metric and a non-viewer outcome metric. At block 504, content scoring module 138 calculates a relevance metric. At block 506, content scoring module 138 calculates an affinity metric. At block 508, content scoring module 138 calculates a voting metric. At block 510, a score is determined for the content item based on one or more of the calculated viewer outcome metric, non-viewer outcome metric, relevance metric, affinity metric, and voting metric.

In one embodiment, one or more additional metrics are calculated, which may include one or more additional outcome metrics, relevance metrics, affinity metrics, and/or voting metrics. Likewise, in one embodiment, one or more of the metrics described in process 500 may be omitted from calculation and/or determination of the score for one or more content items. The score for different content items may be determined based on a different set of metrics and/or a different calculation based on the metrics. For example, different types of content items may be evaluated differently, such as member-submitted questions and answers as compared to member-submitted external references. Furthermore, scores for content items may be determined for different purposes, and a different set of metrics and/or a different calculation based on the metrics. For example, the exact determination of a content item score may differ for the purposes of selecting top content for display, selecting customized content for display to a particular member, identifying quality content to persist, or for other purposes.

### Selecting Content for Display Based on Scoring Metrics

As mentioned above, the scores of content items may be a factor in determining which content items are displayed to a user. Returning again to FIG. 2, at block 208, content scoring module 138 scores content item 254. As mentioned above, content scoring module 138 may use metadata 256 and/or interaction metadata 258 to score content item 254. At decision block 210, the score is used to determine which content items to display to other members of the extended group. In one embodiment, content items that are not automatically displayed may still be accessed by members of the extended group. Therefore, interactions between the content item and members of the extended group may continue to be tracked regardless of the decision at decision block 210 while the content item remains in the system.

In one embodiment, the scores of content items are used for selecting top content for display. For example, for content items associated with a particular section, the scores may be used to select top content to display in association with the particular section. For example, the top content may be displayed under the section heading in a syllabus interface on a course webpage. Alternatively and/or in addition, the same top content or different top content (e.g. top content selected using a different function or metrics) may be displayed in a client learning module 114 when the particular section is selected.

In one embodiment, the scores of content items are used for selecting customized content for display to a particular member of an extended group based on one or more individual characteristics of the particular member. Individual characteristics of a member may include current courses, past courses, a major of study, one or more metrics related to the member's performance in various courses and/or subjects, a member participation metric with respect to the current extended group or another extended group, or any other characteristic of the member that may be tracked. For example, if a member has poor performance in the subject of Math, then customized content may be displayed to the member to provide extra practice in the subject of Math.

In one embodiment, the scores of content items are used for determining “quality content” which, as mentioned herein in greater detail, may continue to be available to the extended group after the user that provided the content has left the extended group.

### Example Process For Managing An Extended Group

As used herein, the term “extended group” refers to an extended group that includes members registered in different course offerings of the same course, such as course offerings that overlap, course offerings with different students, course offerings with different schedules and/or course offerings corresponding to different geographic locations, such as different campuses.

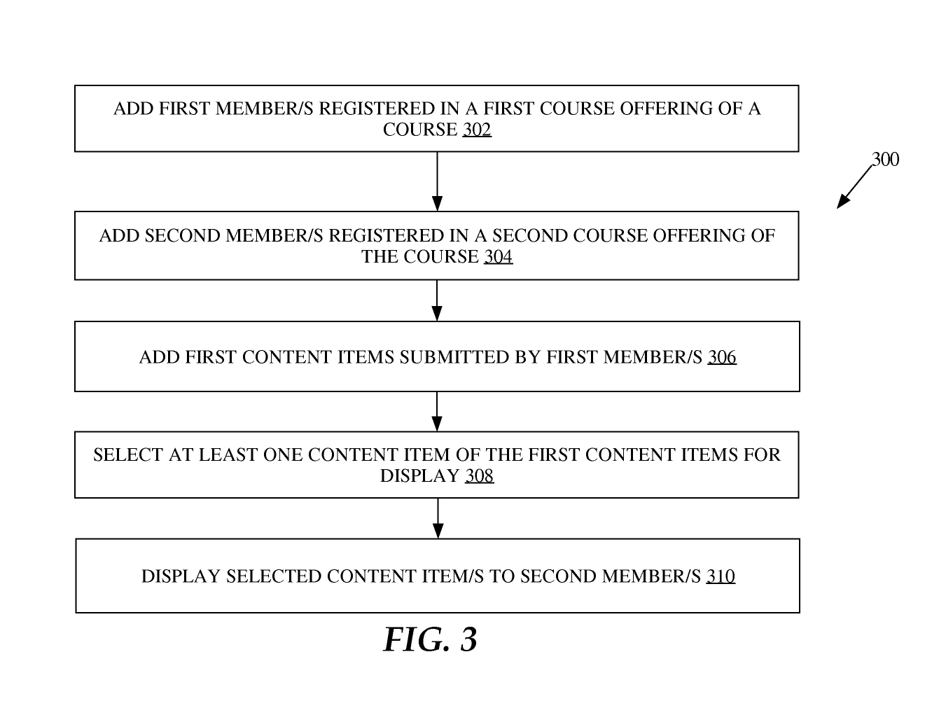

FIG. 3 is a flow diagram that illustrates an embodiment of a process for managing an extended group for a course. Process 300 is performed by one or more computing devices and/or processes thereof, such as computing device 600. For example, one or more classroom management server devices 130 may perform process 300.

At block 302, social classroom application module 132 automatically adds one or more first members to an extended group corresponding to a course. The one or more first members are added to the extended group based on a current registration status of the one or more first members relative to the course. For example, the one or more first members may start a first offering of the course at a first time.

At block 304, social classroom application module 132 automatically adds one or more second members to the extended group. The one or more second members are added to the extended group based on a current registration status of the one or more second members relative to the course. For example, the one or more second members may start a second offering of the course at a second time.

At block 306, social classroom application module 132 adds first content items submitted by the one or more first members to a social content set. In one embodiment, the course is divided into a plurality of ordered sections, and the first content items are submitted for a first section of the course, and the social content set, to which the first content items are added, corresponds to the first section. The one or more first members are provided access to the first section of the course based on the schedule of the first course offering.

At block 308, social classroom application module 132 selects at least one selected content item of the social content set corresponding to the first section for display. In one embodiment, social classroom application module 132 selects the selected content item/s based on content item scores generated by content scoring module 138. In one embodiment, one or more content item scores are based on performance assessments performed by performance assessment module 136, such as a viewer outcome metric and a non-viewer outcome metric.

At block 310, the selected content item/s are displayed to the one or more second members of the extended group. In one embodiment, the selected content item/s are displayed to the one or more second members of the extended group after the one or more second members are provided access to the first section. In one embodiment, the one or more second members are provided access to the first section of the course based on the schedule of the second course offering.

### Example Process for Removing Members and Curating Content

As used herein, the term “curate” refers to selecting content for retention after the content would have been ordinarily removed. For example, content items submitted by a particular member of an extended group may be ordinarily removed when the particular member is removed from the extended group. In this manner, members of the extended group may collaborate with other current members by submitting social content that is managed by social classroom application module 132, and social classroom application module 132 will remove content items that do not meet certain criteria. In one embodiment, content items that do not meet certain criteria may be removed even when they are submitted by users who are still current members of the extended group. As noted above, the criteria for retaining content items may be a function of one or more scores generated by content scoring module 138. Furthermore, as described above, scores generated by content scoring module 138 may be a function of performance assessments performed by performance assessment module 136.

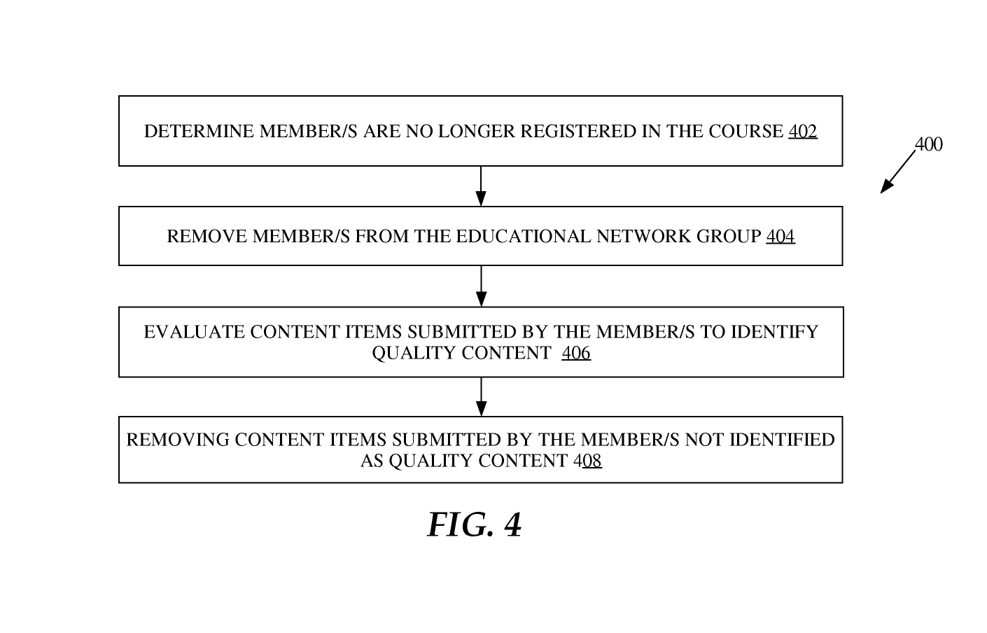

FIG. 4 is a flow diagram that illustrates an embodiment of a process for removing members from an extended group who are no longer registered in the corresponding course. Process 400 is performed by one or more computing devices and/or processes thereof, such as computing device 600. For example, one or more classroom management server devices 130 may perform process 400.

At block 402, social classroom application module 132 determines that one or more members are no longer registered in the course that corresponds to an extended group. For example, the one or more members may no longer be registered in the course because the course offering in which the one or more members were enrolled has finished. Alternatively, the one or more members may drop out of the course. In one embodiment, social classroom application module 132 may evaluate the current registration status of members of the extended group on a regular basis to detect changes in the current registration status of any member. Alternatively, social classroom application module 132 may receive a notification that is triggered by a change in the registration status of a user with respect to any course offering.

At block 404, classroom application module 132 removes the one or more members from the extended group corresponding to the course.

At block 406, classroom application module 132 evaluates content items submitted by the members who are no longer registered in the course to identify quality content. In one embodiment, classroom application module 132 evaluates the content items based on one or more scores determined by content scoring module 138.

At block 408, social classroom application module 132 removes content items, submitted by the removed members, that do not qualify as quality content. In other words, social classroom application module 132 curates content items submitted by prior members in order to identify and persist content items that have been identified as quality content items. In this manner, quality content is persisted beyond the membership of the members that generated the quality content. Because one or more scoring metrics can change, the score of a content item can change over time. Therefore, a content item that has been identified as quality content may be periodically re-evaluated to determine if the content item still qualifies as quality content. When the content item no longer meets the criteria to persist, social classroom application module 132 may remove the content item.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

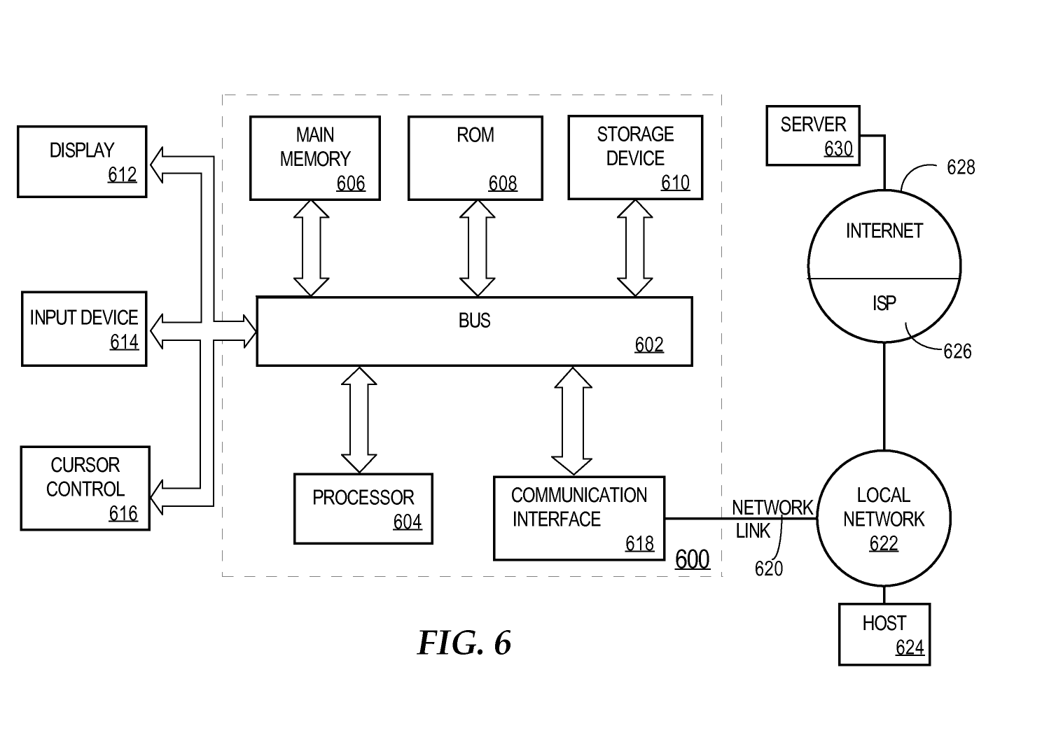

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
establishing an extended group for a course;
enabling members of the extended group to access content items provided by other members of the extended group;
wherein the course is divided into a plurality of ordered sections;
automatically adding one or more first members to the extended group based on the one or more first members being registered in a first course offering of the course;
after a first ordered section of the course has been completed in the first course offering, and before a last ordered section of the course has been completed in the first course offering, performing the steps of:
starting a second course offering of the course;
automatically adding one or more second members to the extended group based on the one or more second members being registered in the second course offering of the course; and
while the second course offering is in the first section, allowing the one or more second members to access at least some of the content items that were provided by the one or more first members when the first course offering was in the first section;
wherein the method is performed by one or more computing devices.

2. The method of claim 1, further comprising automatically removing the one or more first members from the extended group when the first course offering ends.

3. The method of claim 1, further comprising:
determining scores for content items provided by members of the extended group;
based on the scores, determining that a first content item, provided by a first member of the extended group, qualifies as a quality content item;
based on the scores, determining that a second content item, provided by the first member of the extended group, does not qualify as a quality content item;
in response to the first member no longer being a member of the extended group, performing the steps of:
ceasing to make the second content item available to members of the extended group; and
continuing to make the first content item available to members of the extended group.

4. The method of claim 1, further comprising:
determining scores for the content items that were provided by the one or more first members when the first course offering was in the first section;
based on the scores of the content items, selecting at least one selected content item for display with respect to the first section;
wherein allowing the one or more second members to access at least some of the content items that were provided by the one or more first members when the first course offering was in the first section comprises displaying the at least one selected content item in association with the first section.

5. The method of claim 1, further comprising:
determining scores for content items provided by members of the extended group; and
determining which content items are made available or displayed to members of the extended group based on the scores.

6. The method of claim 5 wherein determining scores for content items includes scoring a particular content item by performing the steps of:
calculating a viewer outcome metric based on a performance of one or more members of the extended group that have viewed the particular content item;
calculating a non-viewer outcome metric based on a performance of more members of the extended group that have not viewed the particular content item;
determining a score for the particular content item based at least in part on the viewer outcome metric and the non-viewer outcome metric.

7. The method of claim 1, wherein displaying the at least one selected content item to the one or more second members comprises customizing the at least one selected content item for a particular member based on one or more properties of the one or more content items and one or more properties the particular member.

8. The method of claim 1, further comprising
starting a related course offering of a related course comprising a related section corresponding to a selected section of the course;
automatically adding one or more third members to the extended group based on the one or more third members being registered in the related course offering of the related course; and
while the related course offering is in the related section, allowing the one or more third members to access at least some of the content items that were provided by the one or more first members when the first course offering was in the related section.

9. A method comprising:
establishing an extended group for a course;
enabling members of the extended group to access content items provided by other members of the extended group;
obtaining performance information that indicates how well members of the extended group performed on one or more activities related to the course;
obtaining interaction information that indicates which members of the extended group interacted with a particular content item;
determining scores for content items provided to the extended group by members of the extended group, wherein determining scores includes determining a score for the particular content item by:
based on the performance information and the interaction information, calculating a viewer outcome metric for the particular content item based on performance of one or more members of the extended group that have interacted with the particular content item;
based on the performance information and the interaction information, calculating a non-viewer outcome metric for the particular item based on performance of more members of the extended group that have not interacted with the particular content item; and
determining the score for the particular content item based at least in part on the viewer outcome metric and the non-viewer outcome metric;
wherein the method is performed by one or more computing devices.

10. The method of claim 9, wherein determining scores for content items includes scoring a particular content item by performing the steps of:
calculating a relevance metric for the particular content item that quantifies a level of relevance that the particular content item has with respect to at least one of the course and a particular ordered section of the course;
determining a score for the particular content item based at least in part on the relevance metric.

11. The method of claim 9, wherein determining scores for content items includes scoring a particular content item by performing the steps of:
calculating an affinity metric for the particular content item that quantifies a level of interaction between members of the extended group and the particular content item;
determining a score for the particular content item based at least in part on the affinity metric.

12. The method of claim 9, wherein determining scores for content items includes scoring a particular content item by performing the steps of:
calculating a voting metric for the particular content item based on voting by members of the extended group;
determining a score for the particular content item based at least in part on the voting metric.

13. The method of claim 9, further comprising, based on the scores, selecting top content of the content items associated with a particular section for display in association with the particular section.

14. The method of claim 9, further comprising, based on the scores, selecting customized content for display to a particular member of an extended group based on one or more individual characteristics of the particular member.

15. The method of claim 9, further comprising, based on the scores, determining one or more persisted content items to retain as available to the extended group after a user that provided the one or more persisted content items has left the extended group.

16. A non-transitory computer-readable medium storing instructions which, when executed by one or more processors, cause the one or more processors to perform:
establishing an extended group for a course;
enabling members of the extended group to access content items provided by other members of the extended group;
wherein the course is divided into a plurality of ordered sections;
automatically adding one or more first members to the extended group based on the one or more first members being registered in a first course offering of the course;
after a first ordered section of the course has been completed in the first course offering, and before a last ordered section of the course has been completed in the first course offering, performing the steps of:
starting a second course offering of the course;
automatically adding one or more second members to the extended group based on the one or more second members being registered in the second course offering of the course; and
while the second course offering is in the first section, allowing the one or more second members to access at least some of the content items that were provided by the one or more first members when the first course offering was in the first section.

17. The non-transitory computer-readable medium of claim 16, wherein the instructions, when executed by the one or more processors, further cause the one or more processors to perform automatically removing the one or more first members from the extended group when the first course offering ends.

18. The non-transitory computer-readable medium of claim 16, wherein the instructions, when executed by the one or more processors, further cause the one or more processors to perform:
determining scores for content items provided by members of the extended group;
based on the scores, determining that a first content item, provided by a first member of the extended group, qualifies as a quality content item;
based on the scores, determining that a second content item, provided by the first member of the extended group, does not qualify as a quality content item;
in response to the first member no longer being a member of the extended group, performing the steps of:
ceasing to make the second content item available to members of the extended group; and
continuing to make the first content item available to members of the extended group.

19. The non-transitory computer-readable medium of claim 16, wherein the instructions, when executed by the one or more processors, further cause the one or more processors to perform:
determining scores for the content items that were provided by the one or more first members when the first course offering was in the first section;
based on the scores of the content items, selecting at least one selected content item for display with respect to the first section;
wherein allowing the one or more second members to access at least some of the content items that were provided by the one or more first members when the first course offering was in the first section comprises displaying the at least one selected content item in association with the first section.

20. The non-transitory computer-readable medium of claim 16, wherein the instructions, when executed by the one or more processors, further cause the one or more processors to perform:
determining scores for content items provided by members of the extended group; and
determining which content items are made available or displayed to members of the extended group based on the scores.

21. The non-transitory computer-readable medium of claim 20, wherein determining scores for content items includes scoring a particular content item by performing the steps of:
calculating a viewer outcome metric based on a performance of one or more members of the extended group that have viewed the particular content item;
calculating a non-viewer outcome metric based on a performance of more members of the extended group that have not viewed the particular content item;
determining a score for the particular content item based at least in part on the viewer outcome metric and the non-viewer outcome metric.

22. The non-transitory computer-readable medium of claim 16, wherein displaying the at least one selected content item to the one or more second members comprises customizing the at least one selected content item for a particular member based on one or more properties of the one or more content items and one or more properties the particular member.

23. The non-transitory computer-readable medium of claim 16, wherein the instructions, when executed by the one or more processors, further cause the one or more processors to perform:
starting a related course offering of a related course comprising a related section corresponding to a selected section of the course;
automatically adding one or more third members to the extended group based on the one or more third members being registered in the related course offering of the related course; and
while the related course offering is in the related section, allowing the one or more third members to access at least some of the content items that were provided by the one or more first members when the first course offering was in the related section.

24. A non-transitory computer-readable medium storing instructions which, when executed by one or more processors, cause the one or more processors to perform:
establishing an extended group for a course;
enabling members of the extended group to access content items provided by other members of the extended group;
obtaining performance information that indicates how well members of the extended group performed on one or more activities related to the course;
obtaining interaction information that indicates which members of the extended group interacted with a particular content item;
determining scores for content items provided to the extended group by members of the extended group, wherein determining scores includes determining a score for the particular content item by:
based on the performance information and the interaction information, calculating a viewer outcome metric for the particular content item based on performance of one or more members of the extended group that have interacted with the particular content item;
based on the performance information and the interaction information, calculating a non-viewer outcome metric for the particular item based on performance of more members of the extended group that have not interacted with the particular content item; and
determining the score for the particular content item based at least in part on the viewer outcome metric and the non-viewer outcome metric.

25. The non-transitory computer-readable medium of claim 24, wherein determining scores for content items includes scoring a particular content item by performing the steps of:
calculating a relevance metric for the particular content item that quantifies a level of relevance that the particular content item has with respect to at least one of the course and a particular ordered section of the course;
determining a score for the particular content item based at least in part on the relevance metric.

26. The non-transitory computer-readable medium of claim 24, wherein determining scores for content items includes scoring a particular content item by performing the steps of:
calculating an affinity metric for the particular content item that quantifies a level of interaction between members of the extended group and the particular content item;
determining a score for the particular content item based at least in part on the affinity metric.

27. The non-transitory computer-readable medium of claim 24, wherein determining scores for content items includes scoring a particular content item by performing the steps of:
calculating a voting metric for the particular content item based on voting by members of the extended group;
determining a score for the particular content item based at least in part on the voting metric.

28. The non-transitory computer-readable medium of claim 24, further comprising, based on the scores, selecting top content of the content items associated with a particular section for display in association with the particular section.

29. The non-transitory computer-readable medium of claim 24, further comprising, based on the scores, selecting customized content for display to a particular member of an extended group based on one or more individual characteristics of the particular member.

30. The non-transitory computer-readable medium of claim 24, further comprising, based on the scores, determining one or more persisted content items to retain as available to the extended group after a user that provided the one or more persisted content items has left the extended group.
